(19) United States
(12) Patent Application Publication
(10) Pub. No.: US 2026/0229813 A1
(43) Pub. Date: Aug. 6, 2026

(54) MAGNETIC WATERPROOF CONNECTION DEVICE

(71) Applicants: KUNSHAN AMPHENOL ZHENGRI ELECTRONICS CO., LTD., Kunshan City (CN); AMPHENOL LTW TECHNOLOGY CO., LTD., New Taipei City (TW)

(72) Inventors: Fan-Cheng HUANG, New Taipei City (TW); Kun-Te KO, New Taipei City (TW)

(21) Appl. No.: 19/094,794

(22) Filed: Mar. 28, 2025

(30) Foreign Application Priority Data
Feb. 6, 2025 (TW) 114104415

(51) Int. Cl. H01R 13/52; H01R 13/62

(52) U.S. Cl. CPC H01R 13/5219; H01R 13/6205

(57) ABSTRACT

A magnetic waterproof connection device having a first connector and a second connector is provided. The first connector has a first connecting body, a first terminal seat, and a first plug-in portion having a plugging end. A first terminal and a first magnetic member are arranged in the first terminal seat. The second connector has a second connecting body, a second terminal seat, and a second plug-in portion corresponding to the plugging end. A second terminal and a second magnetic member are arranged in the second terminal seat. An annular sealing structure is arranged outside the second plug-in portion. An internal wall of the plugging end is tapered. The annular sealing structure has a first sealing ring and a second sealing ring pressing on the internal wall of the plugging end.

### BACKGROUND OF THE DISCLOSURE

### TECHNICAL FIELD

This disclosure is directed to a connector, in particular to a magnetic waterproof connection device.

### DESCRIPTION OF RELATED ART

A waterproof magnetic connector of related art is usually designed with a shape of an annular gasket, and waterproof may be performed by radially pressuring a gasket with a large attracting force. However, the attracting force mentioned above should be generated by a magnetic field larger than usual, this connector with a larger joint area tends to occupy a larger volume and space.

In views of this, in order to solve the above disadvantage, the inventor studied related technology and provided a reasonable and effective solution in this disclosure.

### SUMMARY OF THE INVENTION

A main purpose of this disclosure is to provide a waterproof magnetic connection device having a gasket used for waterproofing. The gasket is additionally added with two sealing rings spaced from each other. The sealing rings are respectively defined with diameters different from each other and designed to be tapered, and thereby obliquely contacting and interfering an internal surface of a counterpart connector. Therefore, air between the connectors may be easily squeezed out to effectively reduce a pressure on the gasket. Accordingly, this disclosure has functions of effortless coupling and waterproof. A magnet with less attracting force and smaller attracting area may be applied in this disclosure, and the connector may therefore be made compact.

In order to achieve the purpose mentioned above, this disclosure provides a magnetic waterproof connection device having a first connector and a second connector. The first connector has a first connecting body, a first plug-in portion protruded from the first connecting body disposed, and a first terminal seat arranged on the first plug-in portion. The first plug-in portion has a plugging end. The first terminal seat is arranged in the first plug-in portion corresponding to the plugging end, and at least one first terminal and at least one first magnetic member are arranged in the first terminal seat. The second connector has a second connecting body, a second plug-in portion protruded from the second connecting body and a second terminal seat arranged on the second plug-in portion. The second plug-in portion is disposed corresponding to the plugging end, and the second terminal seat is arranged in the second plug-in portion. At least one second terminal and at least one second magnetic member are arranged in the second terminal seat. Specifically, the second plug-in portion has an annular sealing structure outside thereof, the annular sealing structure has a sealing body and further has a first sealing ring and a second sealing ring annually arranged on the sealing body and spaced from each other. An internal surface of the plugging end of the first plug-in portion is tapered, and the first sealing ring and the second sealing ring press on the internal surface of the plugging end when the first connector is coupled to the second connector.

### BRIEF DESCRIPTION OF THE DRAWINGS

FIG. 1 is a perspective view of this disclosure in a detached status.

FIG. 2 is a perspective view of this disclosure in a coupled status.

FIG. 3 is a cross-sectional view at a portion of this disclosure in a detached status.

FIG. 3A is an enlarged view of a portion marked A in FIG. 3.

FIG. 4 is a cross-sectional view at a portion of this disclosure in a coupled status.

FIG. 4A is an enlarged view of a portion marked A in FIG. 4.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

Detailed descriptions and technical contents of this disclosure is described in the flowing paragraph with reference to the drawings. However, the drawings are attached only for illustration and are not intended to limit this disclosure.

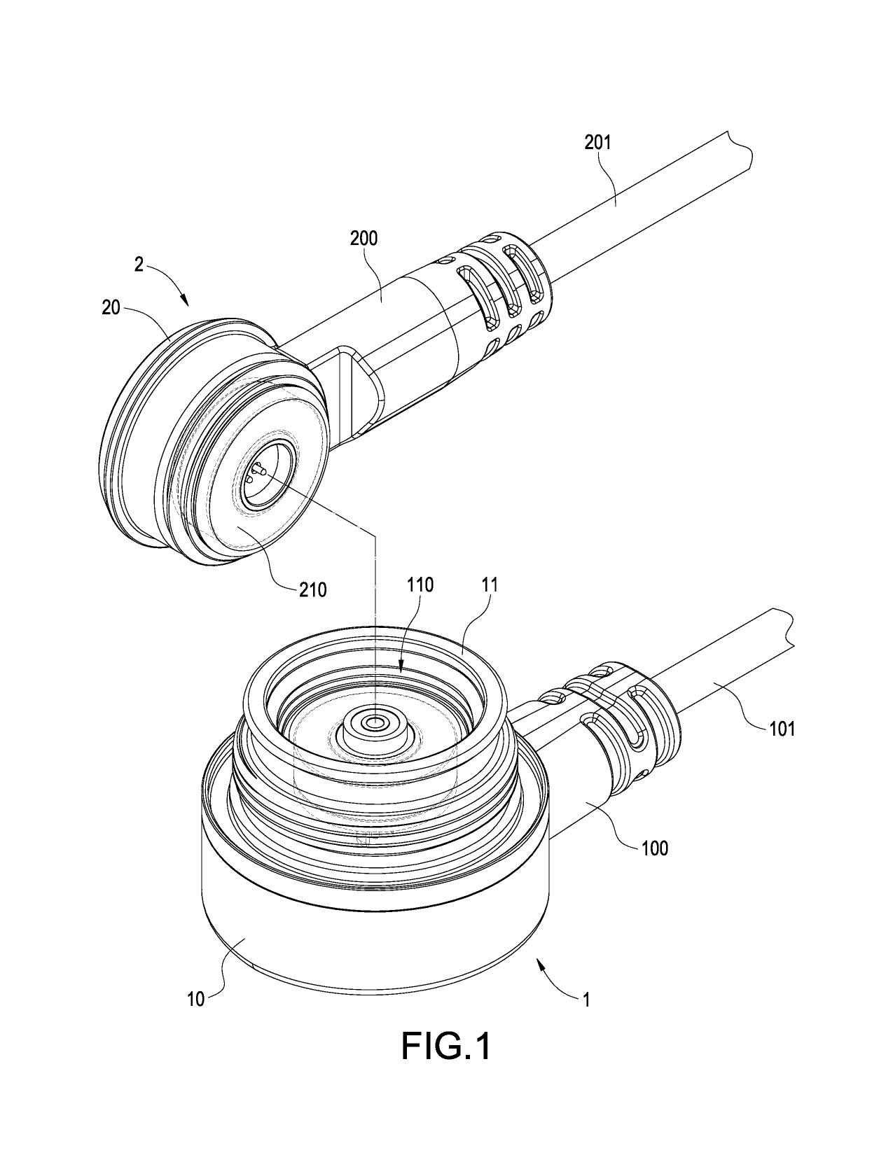

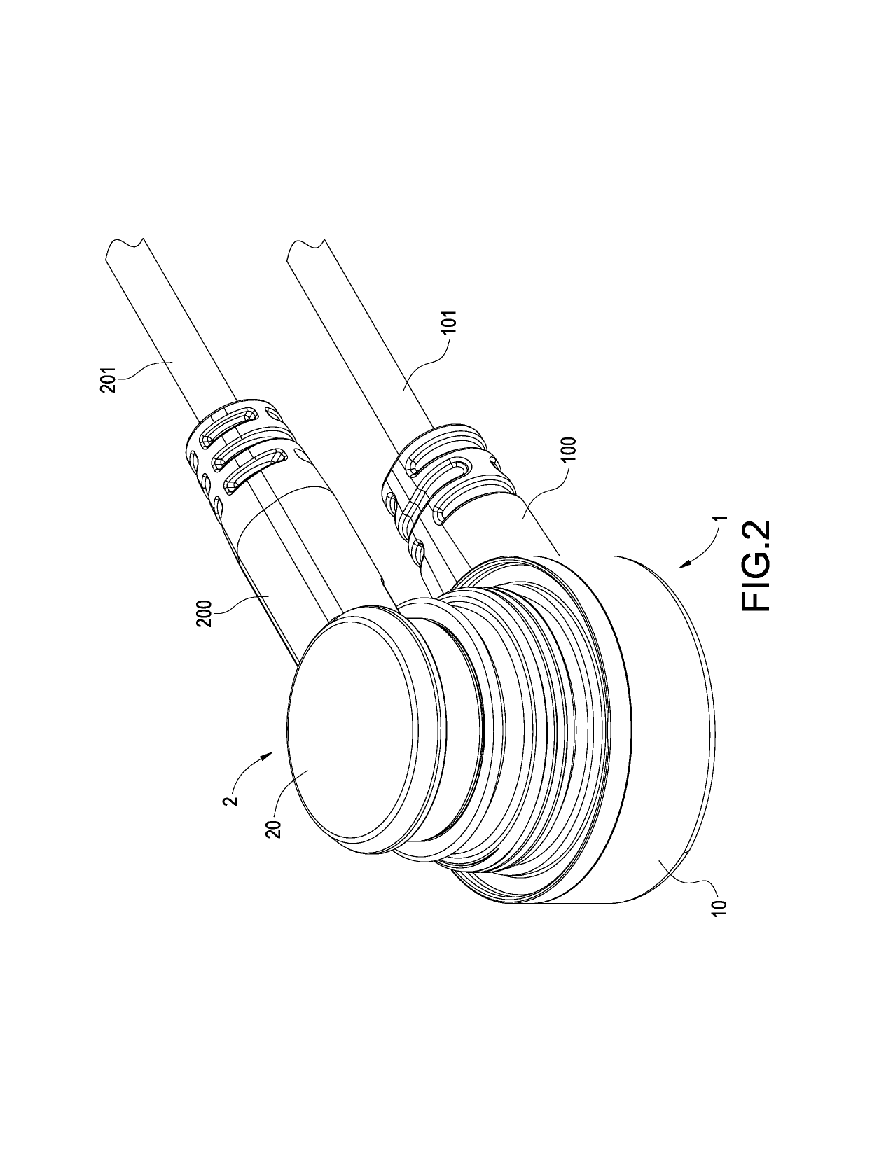

FIG. 1 and FIG. 2 are perspective views of this disclosure respectively in a detached status and in a coupled status. This disclosure is directed to a magnetic waterproof connection device having a first connector 1 and a second connector 2.

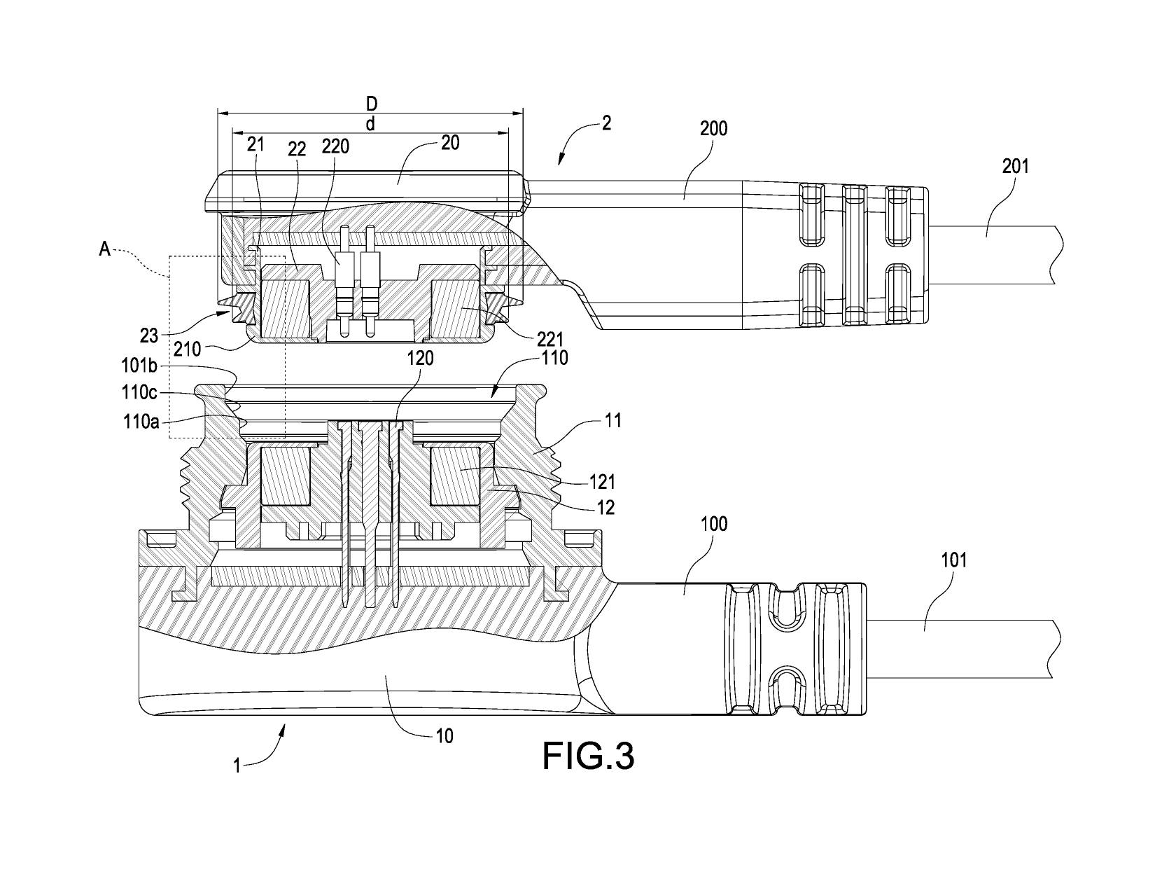

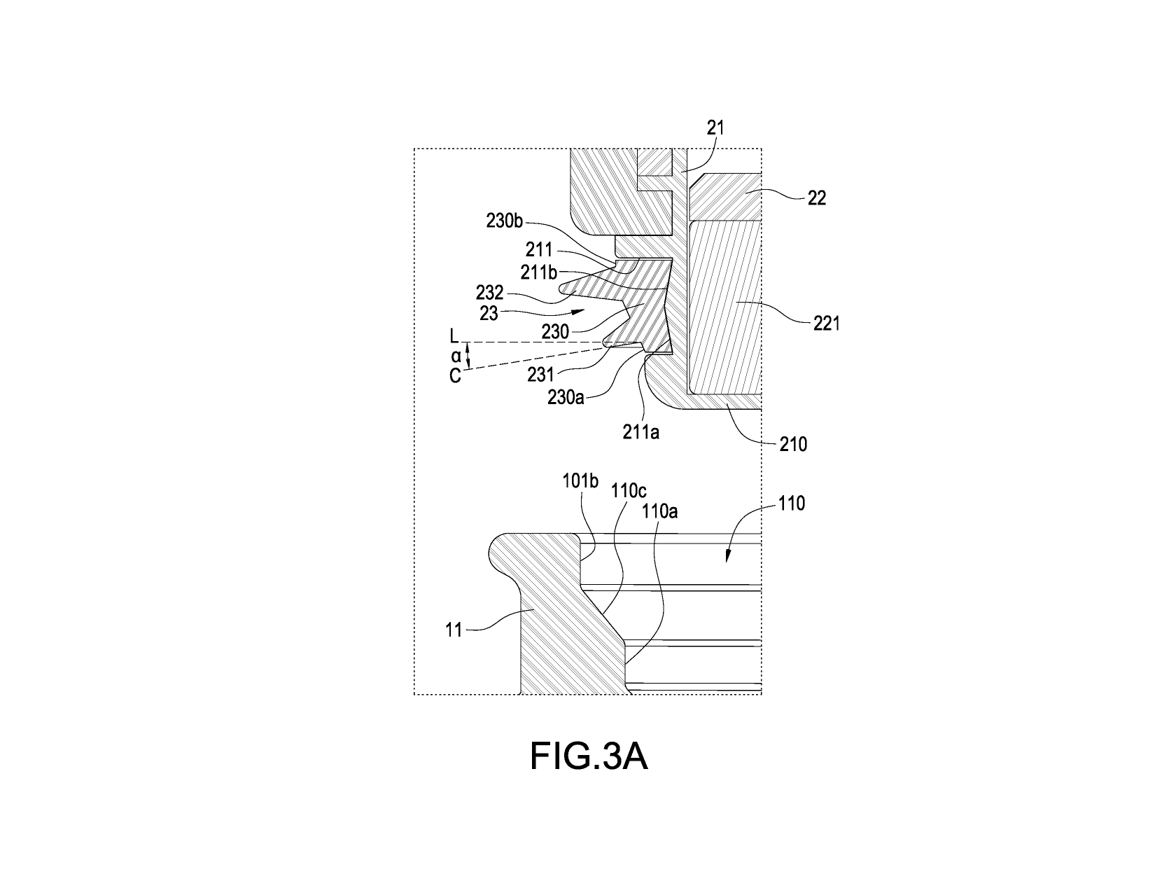

Referring to FIG. 3, the first connector 1 has a first connecting body 10 and has a first plug-in portion 11 and a first terminal seat 12 protruded from connecting body 10. The first connecting body 10 may have a first buffering end 100 and connect to a first cable 101. The first plug-in portion 11 may be arranged on a surface on the first connecting body 10, so that the first connector 1 may be coupled with the second connector 2 along a direction perpendicular to the first cable 101. The first plug-in portion 11 has a plugging end 110 allowing the first terminal seat 12 to be disposed in the first plug-in portion 11 corresponding to the plugging end 110. At least one first terminal 120 and at least one first magnetic member 121 are arranged in the first terminal seat 12. According to one embodiment of this disclosure, the first magnetic member 121 is annular and disposed around the first terminal 120.

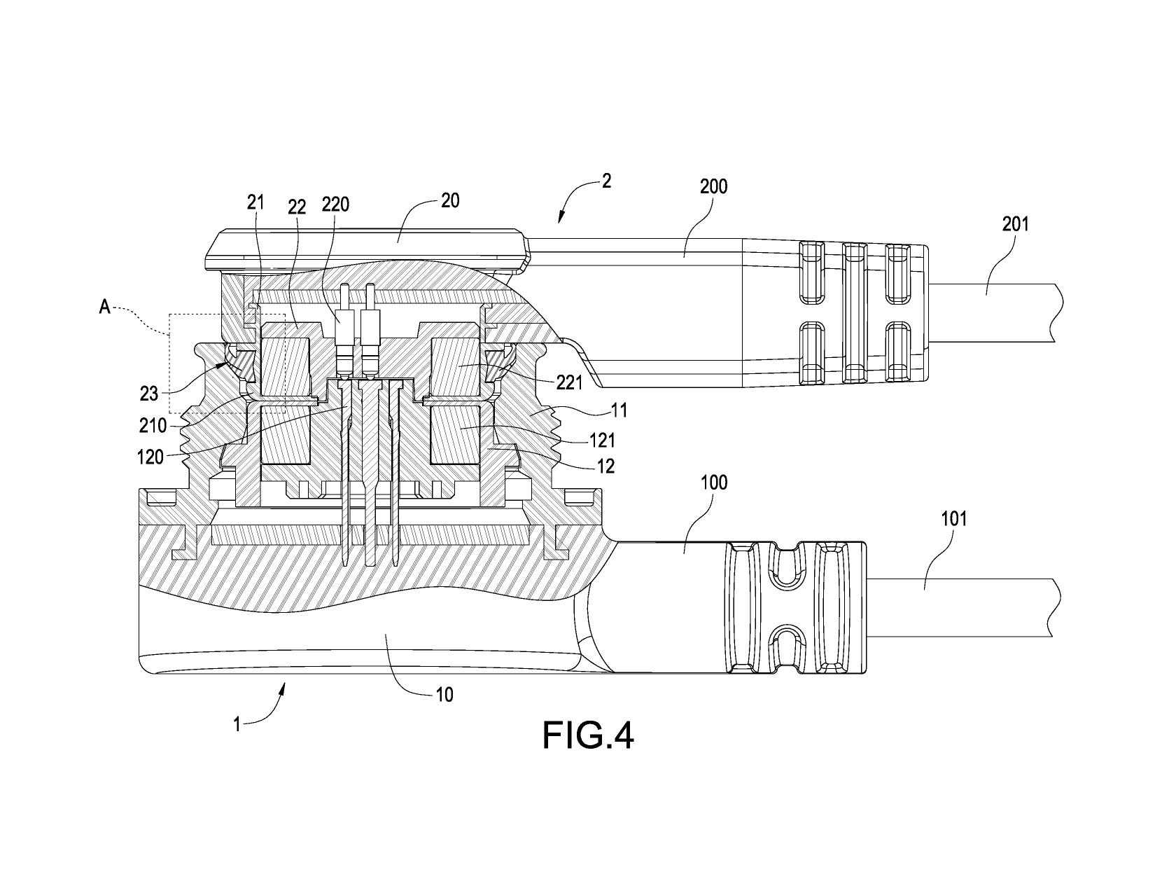

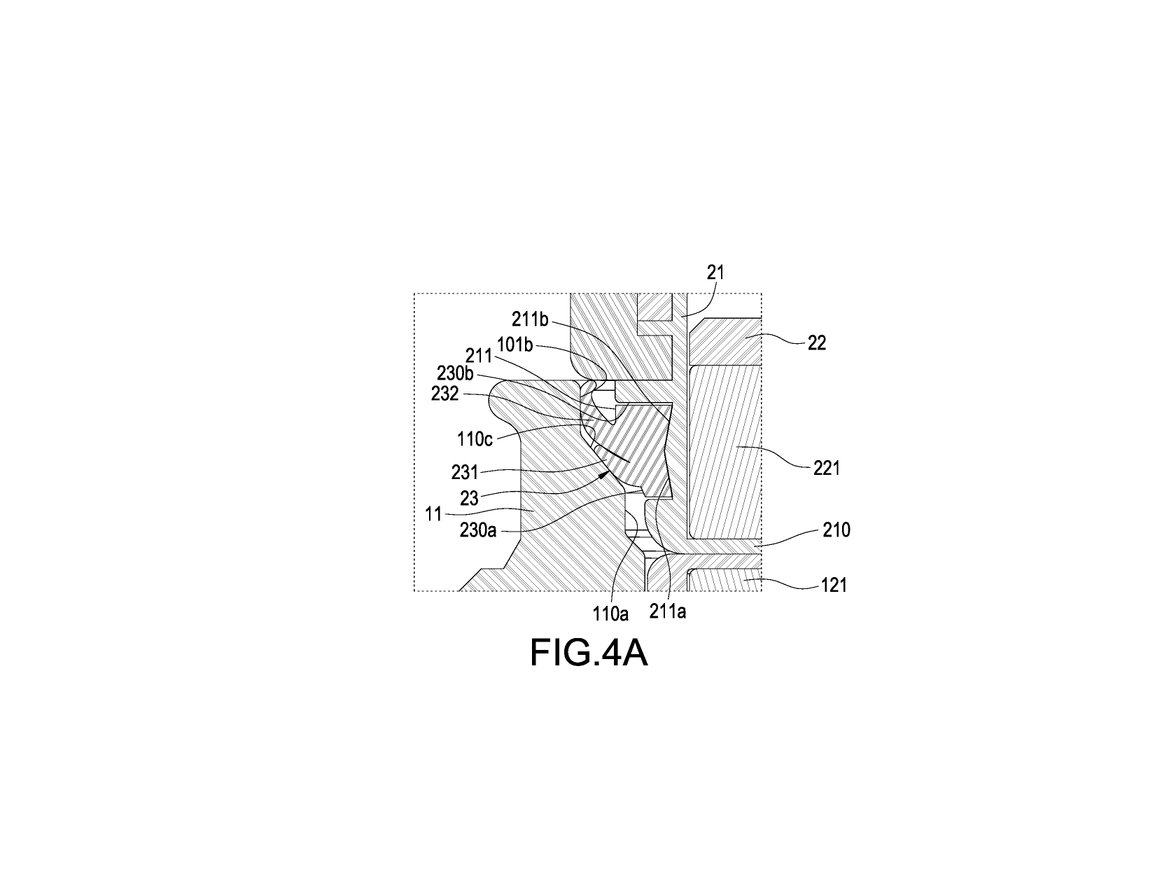

Accordingly, the second connector 2 has a second connecting body 20, a second plug-in portion 21 protruded from the second connecting body 20 and a second terminal seat 22 arranged on the second plug-in portion 21. The second connecting body 20 may have a second buffering end 200 and connect to second magnetic member 201. The second plug-in portion 21 may be arranged on a surface on the second connecting body 20, so that the second connector 2 may be coupled with the first connector 1 along a direction perpendicular to the second cable 201. The second plug-in portion 21 is disposed corresponding to the plugging end 110 of the first connector 1, so that at least the front end 210 of the second terminal seat 22 is allowed to be plugged in the plugging end 110 and the second terminal seat 22 is disposed in the second plug-in portion 21. At least one second terminal 220 and at least one second magnetic member 221 are arranged in the second terminal seat 22. According to this embodiment, the second magnetic member 221 is annular and disposed to surround the second terminal 220. Therefore, according to FIG. 4, the second plug-in portion 21 is plugged into the plugging end 110 of the first connector 1 when the first connector 1 is coupled with the second connector 2 so that the first terminal 120 is coupled with the second terminal 220 to be electrically connected with each other. Meanwhile, the first magnetic member 121 and the second magnetic member 221 may be attracted to each other by placing the first terminal seat 12 to be close to the second terminal seat 22. Furthermore, the first connector 1 and the second connector 2 are prevented from separating easily.

Referring to FIGS. 3 and 3A together, this disclosure is directed to the second plug-in portion 21 mentioned above which is provided with an annular sealing structure 23, the annular sealing structure 23 has a sealing body 230 and further has a first sealing ring 231 and a second sealing ring 232 sealing body 230 annularly arranged on an outer side thereof and spaced form each other. Specifically, an external diameter of the first sealing ring 231 is less than an external diameter of the second sealing ring 232, and the first sealing ring 231 is closer to an end surface of the second plug-in portion 21 than the second sealing ring 232. According to one embodiment of this disclosure, the second plug-in portion 21 has an annular embedding groove 211 disposed on a lateral surface thereof. The annular embedding groove 211 is embedded with the sealing body 230 therein to allow the first sealing ring 231 and the second sealing ring 232 to be laterally protruded therefrom. Specifically, a first embedding surface 211a and a second embedding surface 211b may be defined in the annular embedding groove 211, and the first embedding surface 211a and the second embedding surface 211b are tapered to connecter with each other at a ridge, so as to sheath the sealing body 230 to the sealing body 230 more tightly. Further, as shown in FIG. 3A, the sealing body 230 may have a first annular surface 230a and a second annular surface 230b on an external surface thereof to allow the first sealing ring 231 and the second sealing ring 232 to be disposed thereon. Specifically, the first annular surface 230a may be tapered, so that an included angle α is formed between an extended surface C of the first sealing ring 231 and a transverse plane L, so that a gap between the first sealing ring 231 and the second sealing ring 232 is enlarged to reduce a pressure to the first sealing ring 231 caused by coupling.

As shown in FIGS. 4 and 4A, the internal surface of the plugging end 110 of the first plug-in portion 11 may be tapered. Specifically, the plugging end 110 may have a first internal surface 110a and a second internal surface 110b disposed in sequence from inside to the outside, and further have a tapered internal surface 110c disposed between the first internal surface 110a and the second internal surface 110b, so that the first sealing ring 231 and the second sealing ring 232 of the annular sealing structure 23 may press on tapered internal surface 110c when the first connector 1 is coupled with the second connector 2 for sealing or waterproof.

Accordingly, the magnetic waterproof connection device of this disclosure may be implemented via the structure above-mentioned.

Therefore, according to the magnetic waterproof connection device of this disclosure, the annular sealing structure 23 has a first sealing ring 231 and a second sealing ring 232 spaced from each other, which are a tapered and provided with different external diameters, so as to obliquely contact and interference the internal surface of the first connector 1. Accordingly, air between the first connector 1 and the second connector 2 may be easily squeezed out, so that a pressure to the annular sealing structure 23 is effectively decreased and this disclosure may therefore be waterproof and docked effortlessly. Moreover, the first connector 1 and the second connector 2 can be made compact as well because the attracting force is reduced and the magnet attracting area is decreased.

In summary, this disclosure achieves the purpose mentioned above to solve the issues of prior art. Accordingly, this disclosure is novel and inventive, and therefore patentable. The application here files an application according to the Patent Law. The applicant respectfully requests further examination and approval in order to protect the rights of the inventor.

While this disclosure has been described by means of specific embodiments, numerous modifications and variations may be made thereto by those skilled in the art without departing from the scope and spirit of this disclosure set forth in the claims.

What is claimed is:

1. A magnetic waterproof connection device, comprising:
a first connector, comprising a first connecting body, comprising a first plug-in portion protruded from the first connecting body and a first terminal seat arranged on the first plug-in portion, wherein the first plug-in portion comprises a plugging end, the first terminal seat is arranged in the first plug-in portion corresponding to the plugging end, and at least one first terminal and at least one first magnetic member are arranged in the first terminal seat; and
a second connector, comprising a second connecting body, a second plug-in portion protruded from the second connecting body and a second terminal seat arranged on the second plug-in portion, wherein the second plug-in portion is arranged corresponding to the plugging end, the second terminal seat is arranged in the second plug-in portion, and at least one second terminal and at least one second magnetic member are arranged in the second terminal seat,
wherein the second plug-in portion comprises an annular sealing structure on an outer side thereof, the annular sealing structure comprises a sealing body, the sealing body further comprises a first sealing ring and a second sealing ring annularly arranged on the outer side thereof and spaced form each other, the first plug-in portion comprises an internal surface of a tapered shape and defined in the plugging end, and the first sealing ring and the second sealing ring press on the internal surface of the plugging end when the first connector is coupled with the second connector.

2. The magnetic waterproof connection device according to claim 1, wherein the first connecting body comprises a first buffering end and connects to a first cable, and the second connecting body comprises a second buffering end and connects to a second magnetic member.

3. The magnetic waterproof connection device according to claim 1, wherein the plugging end comprises a first internal surface and a second internal surface sequentially arranged from inside to outside, and the plugging end further comprises a tapered internal surface arranged between the first internal surface and the second internal surface.

4. The magnetic waterproof connection device according to claim 1, wherein the first magnetic member is annular and disposed to surround the first terminal, and the second magnetic member is annular and disposed to surrounding the second terminal.

5. The magnetic waterproof connection device according to claim 1, wherein the second plug-in portion comprises an annular embedding groove disposed on a lateral surface thereof, the annular embedding groove is embedded with the sealing body therein to allow the first sealing ring and the second sealing ring to be laterally protruded therefrom.

6. The magnetic waterproof connection device according to claim 5, wherein the annular embedding groove comprises a first embedding surface and a second embedding surface therein, and the first embedding surface and the second embedding surface are tapered.

7. The magnetic waterproof connection device according to claim 6, wherein the first embedding surface and the second embedding surface are tapered to connect with each other at a ridge.

8. The magnetic waterproof connection device according to claim 1, wherein the first sealing ring is closer to an end surface of the second plug-in portion than the second sealing ring, and an external diameter of the first sealing ring is less than an external diameter of the second sealing ring.

9. The magnetic waterproof connection device according to claim 1, wherein the sealing body comprises a first annular surface and a second annular surface on an external surface thereof, the first sealing ring is arranged on the first annular surface and the second sealing ring is arranged on the second annular surface.

10. The magnetic waterproof connection device according to claim 9, wherein the first annular surface is tapered.
